(19) United States
(12) Patent Application Publication
(10) Pub. No.: US 2010/0118425 A1
(43) Pub. Date: May 13, 2010

(54) DISTURBANCE REJECTION IN A SERVO CONTROL LOOP USING PRESSURE-BASED DISC MODE SENSOR

(76) Inventor: Menachem Rafaelof, Superior, CO (US)

Correspondence Address: HENSLEY KIM & HOLZER, LLC, 1660 LINCOLN STREET, SUITE 3000, DENVER, CO, 80264, US

(21) Appl. No.: 12/268,720

(22) Filed: Nov. 11, 2008

(51) Int. Cl. G11B 27/36; G11B 21/02

(52) U.S. Cl. 360/31; 360/75

(57) ABSTRACT

Vibration of a rotatable disc is sensed using a pressure sensor positioned adjacent to and spaced apart from a surface of the rotatable disc. The pressure sensor detects pressure variation caused by vibration of the rotatable disc.

### BACKGROUND

The present invention generally relates to controlling transducer movement and, more particularly, to controlling transducer movement responsive to a position error signal within a servo control loop.

A typical data storage disc drive includes a plurality of magnetic recording discs which are mounted to a rotatable hub of a spindle motor and rotated at a high speed. An array of read/write heads is disposed adjacent to surfaces of the discs to transfer data between the discs and a host device. The heads can be radially positioned over the discs by a rotary actuator and a closed loop servo system.

The servo system can operate in two primary modes: seeking and track following. During a seek, a selected head is moved from an initial track to a target track on the corresponding disc surface. Upon reaching the target track, the servo system enters the track following mode wherein the head is maintained over the center of the target track while data is written/read. During track following, prerecorded servo information sensed by the head is demodulated to generate a position error signal (PES), which provides an indication of the position error of the head away from a desired location along the track (e.g., the track center). The PES is then converted into an actuator control signal, which is fed back to the actuator that positions the head.

As the areal density of magnetic disc drives increases, so does the need for more precise position control when track following, especially in the presence of external vibrations which can cause non-repeatable runout (NRRO) of the position error. Disc drives are being incorporated into increasingly diverse types of electronic devices having widely varying vibrational characteristics. For example, disc drives utilized in music and video playback/recording devices can be subjected to speaker induced vibration. Such speaker induced vibration can exceed the track following capabilities of the servo control loop and result in disruption of the music and video stream and associated skipping and/or stalling of the music and video playback/recording and/or failure of the device operation system.

### SUMMARY

Vibration of a rotatable disc is sensed using a pressure sensor adjacent to and spaced apart from a surface of the rotatable disc. The pressure sensor generates a signal indicative of a pressure variation caused by vibration of the rotatable disc. The pressure sensor may include a polyvinylidene fluoride (PVDF) film, and a pair of electrodes on opposite sides of the PVDF film.

A servo control system that controls a position of a read/write head relative to a track on a rotatable disc includes a pressure sensor adjacent to and spaced apart from a surface of the rotatable disc that detects a pressure variation in air caused by vibration of the rotatable disc and generates a vibration sensing signal in response to the pressure variation. An adaptive feed-forward vibration compensation circuit is coupled to the servo control system and to the pressure sensor and generates a feed-forward control signal in response to the vibration sensing signal. The servo control system controls the position of the read/write head in response to the feed-forward control signal.

A method of controlling a position of a read/write head of a rotatable disc includes generating a pressure signal indicative of a pressure variation caused by vibration of the rotatable disc using a pressure sensor, and generating a control signal in response to the pressure signal.

### DESCRIPTION OF THE DRAWINGS

FIG. 1 is a block diagram of disc drive electronic circuits that include a servo controller that is configured in accordance with some embodiments.

FIG. 2 is a block diagram of a servo control loop configured in a track-following mode and which can be partially embodied within the servo controller of FIG. 1, in accordance with some embodiments.

FIG. 3 illustrates a pressure sensor according to some embodiments.

FIG. 4 illustrates a pressure sensor according to some embodiments mounted adjacent a surface of a rotatable disc.

FIG. 5 is a graph that illustrates the correlation of disc modes measured with a PVDF sensor and measured using a PES signal.

FIG. 6 is simplified diagrammatic representation of a disc drive according to some embodiments.

FIG. 7 illustrates a disc ramp assembly including a plurality of pressure sensors according to some embodiments.

FIG. 8 illustrates positioning of a disc ramp assembly including a plurality of pressure sensors according to some embodiments adjacent a disc stack in a disc drive.

FIG. 9 is a simplified diagram illustrating electrical connection of sensors according to some embodiments.

FIG. 10 is a schematic block diagram illustrating positioning of a sensor on an actuator arm according to further embodiments.

### DETAILED DESCRIPTION

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the alt.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions may be exaggerated for clarity. Like numbers refer to like elements throughout.

Although various embodiments of the present invention are described in the context of disc drives for purposes of illustration and explanation only, the present invention is not limited thereto. It is to be understood that the present invention can be more broadly used for any type of servo control loop that can be subject to vibration.

The primary frequency components of NRRO are due to disturbances caused by disc modes. A disc mode is a normal vibration pattern for a data storage disc. A normal mode is a vibration pattern of a physical object that occurs at certain distinct frequencies, depending on the structure and composition of the object. When a disc is vibrating in a disc mode, all parts of the disc move sinusoidally at the same frequency. Costly measures have been used or proposed to reduce NRRO due to disc modes in high capacity drives. These include the use of thicker discs, separator plates between the discs, cover to spindle motor attachment, microactuators or plans to fill the drive with Helium gas. However, these methods may involve increased cost and/or complexity, and/or may lower drive reliability.

As described herein, a secondary sensing capability can be provided within a disc drive to facilitate compensation for disc mode disturbances with addition of feedforward control. Some embodiments provide a simple, easily implemented sensor that can be effectively used to sense disc modes to compensate for their effect.

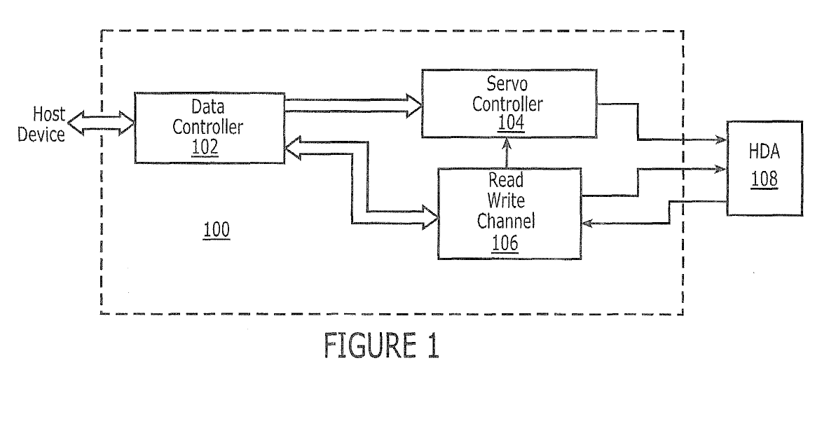

FIG. 1 is a block diagram of disc drive electronic circuits 100 which include a data controller 102, a servo controller 104, and a read write channel 106. Although two separate controllers 102 and 104 and a read write channel 106 have been shown for purposes of illustration and discussion, it is to be understood that their functionality described herein may be integrated within a common integrated circuit package or distributed among more than one integrated circuit package. A head disc assembly (HDA) 108 can include a plurality of data storage discs, a plurality of heads mounted to respective arms and which are moved radially across different data storage surfaces of the discs by a head actuator (e.g., voice coil motor), and a spindle motor which rotates the discs.

Write commands and associated data from a host device can be buffered by the data controller 102. The host device can include, but is not limited to, a desktop computer, a laptop computer, a personal digital assistant (PDA), a digital video recorder/player, a digital music recorder/player, and/or another electronic device that can be communicatively coupled to store and retrieve data in the HDA 108. The data controller 102 carries out buffered write commands by formatting the associated data into blocks with the appropriate header information, and transfers the formatted data via the read/write channel 106 to logical block addresses (LBAs) on a disc in the HDA 108 identified by the associated write command.

The read write channel 106 can convert data between the digital signals processed by the data controller 102 and the analog signals conducted through the heads in the HDA 108. The read write channel 106 provides servo data read from the HDA 108 to the servo controller 104. The servo data can be used to detect the location of the head in relation to LBAs on the disc. The servo controller 104 can use LBAs from the data controller 102 and the servo data to seek the head to all addressed track and block on the disc (i.e., seek mode), and to maintain the head aligned with the track while data is written/read on the disc (i.e., track following mode).

Some embodiments of the servo controller 104 provide an adaptive feed-forward control scheme that utilizes a pressure-based sensor to improve the capability of the servo control loop to reject external disturbances while operating in the track settling mode and the track-following mode and subjected to vibration. An adaptive filter generates filter coefficients to filter the vibration signal and generate a feed-forward signal that controls a head actuator to counteract disturbances to head position caused by the vibration. The filter coefficients are tuned in response to the vibration signal and a PES, which is indicative of head position error, to reduce the PES.

The filter coefficients may be tuned using a modified filtered-X Least Mean Square (LMS) algorithm. The servo controller 104 attempts to adapt the modified filtered-X LMS algorithm to match the unknown disturbance dynamic effects on the servo control loop, and so that the filter coefficients are thereby tuned to cause the feed-forward signal to cancel the deleterious effects of the external disturbances on head position. Accordingly, this may result in a significant reduction of the non-repeatable runout induced by rotational vibration. An exemplary background servo control loop using a filtered-X LMS algorithm is described in U.S. Pat. No. 6,580,579, the entire disclosure of which is incorporated herein by reference as if set forth in its entirety.

Although some embodiments herein will be discussed with respect to a single-input, single-output (SISO) discrete time stochastic system. It will be appreciated that the invention is also applicable to other systems. Moreover, although some embodiments are discussed in the context of the discrete time domain (i.e., digital circuitry), using a sampling time index, k, it will further be appreciated that other embodiments of the invention can be embodied in the continuous time domain (i.e., analog and/or hybrid circuitry).

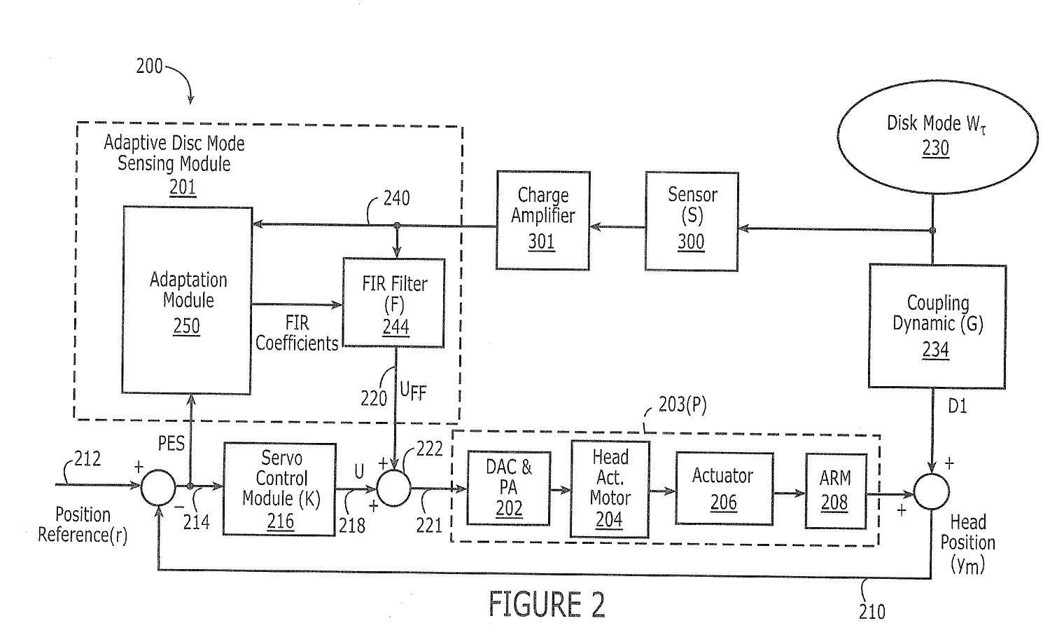

FIG. 2 is a further block diagram of a servo control loop 200 configured in a track settling and track-following mode and which can be partially embodied within the servo controller 104 of FIG. 1 in accordance with some embodiments. Referring to FIG. 2, the HDA 108 can be modeled in the servo control loop 200 as a plant (P) 203 including a digital-to-analog converter (DAC) and power amplifier 202, a head actuator motor (e.g., voice coil motor) 204, an actuator 206, and an actuator arm 208. The position yₘ 210 of a read/write head relative to a given track on a disc is sensed (e.g., from servo data on the disc) and compared to a reference position 212 (desired position, r) of the head to generate a position error signal (PES) 214. The PES 214 is therefore indicative of the difference between the actual and desired positions of the head (i.e., head position error), and is provided to a servo control module 216. The servo control module (K) 216 responds to the value of PES 214 to generate a servo control signal (U) 218.

The servo control signal 218 is combined with a feed-forward signal (U_{FF}) 220 at a summing node 222 to generate a combined control signal 221. The combined control signal 221 can be converted by the DAC/power amplifier 202 into an analog signal, and then amplified and provided to the head actuator motor 204. The head actuator motor 204 is connected to the actuator 206 which moves the actuator arm 208 in response to the amplified control signal supplied to the head actuator motor 204. The read/write head is connected to the actuator arm 208 (e.g., to an end of the actuator arm 208). In this way, servo control module 216 controls the positioning of the read/write bead relative to a selected track on the disc surface during reading/writing of data along the selected track.

As shown in FIG. 2, the disc mode 230 (Wτ) imparts a disturbance component D1 to the head through coupling dynamics 234 (G) which are typically unknown to the servo controller 216.

To enable the servo control loop 200 to sense and compensate for the effects of the disturbance 230 (WT), a sensor 300 is configured to generate a signal that is indicative of the disc motion due to the disc and disc pack modes. The low level signal from the sensor 300 may be amplified by an optional charge amplifier 301 to generate a signal 240. The sensor 300 may include a pressure sensor as described in more detail below. The sensor 300 produces an output proportional to pressure variation in air adjacent to the surface of the disc due to gross motion or modes of vibration of the disc. Accordingly, the signal 240 is indicative of the motion of the disc to be correlated with the disturbance D1 imparted to the head.

An adaptive disc mode sensing module 201 is configured to respond to the signal 240 by generating the feed-forward signal 220 (U_{FF}) to counteract the disturbance D1 to head position. The adaptive disc mode sensing module 201 can include a Finite Impulse Response (FIR) filter 244 (F), and an adaptation module 250.

The signal 240 is filtered by the adaptive Finite Impulse Response (FIR) filter 244 (F) to generate the feed-forward signal 220 (U_{FF}). The FIR filter 244 can be configured as a tapped delay line having a plurality of coefficient weights that are applied to respective ones of a plurality of time-delayed taps filtering the sensed signal 240. The adaptation module 250 tunes the FIR coefficient weights (in the FIR filter 244) in response to the signal 240 and error signal or PES 214. In some embodiments, the adaptation module 250 may use a modified filtered-X LMS algorithm for this timing process. Regardless, the tuning process produces a matching transfer function to estimate the unknown coupling 234 between position of the head and disc motion due to disc modes.

The adaptation module 250 tunes the coefficient weights (“FIR Coefficients”) used by the FIR filter 244 in response to the output vibration signal 240 and the PES 214. The adaptation module 250 may tune the FIR coefficients according to the following equation:

W(n+1)=W(n)+μ*x(n)*PES(n) (1)

In Eq. 1, W(n+1) represent the next set of coefficients for the adaptive FIR filter 244, and ti is the constant determining the rate of convergence and the accuracy of the adaptation process.

Accordingly, the adaptation module 250 tunes the coefficient weights of the FIR filter 244 in response to the PES 214 and the vibration signal 240 to attempt to match the unknown couplings affecting the servo control loop, and to thereby cause the feed-forward signal 220 (U_{FF}) to cancel the deleterious effects of the disturbance on head positioning.

Some embodiments provide a pressure sensor 300 that uses polyvinylidene fluoride (PVDF) as the transducing material. PVDF is a polymeric material with high piezo- and pyro-electric properties. PVDF films provide a set of attractive properties for the development of simple, reliable disc mode sensor. These properties include fast response time, self-inducing charge (no need for external power), low device cost and simple design.

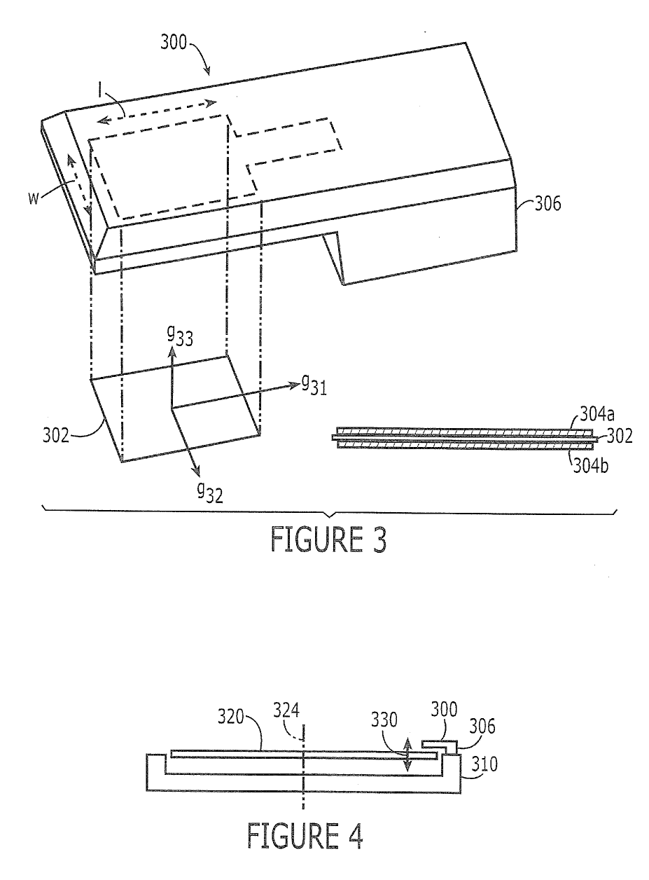

In some embodiments, the sensing element includes a thin segment of PVDF film 302 with two sputtered electrodes 304a, 304b on opposite surfaces thereof. The film 302 may have a thickness of about 28 micrometers (μm). As shown in FIG. 3, the film 302 may be shaped as a small rectangular patch (e.g., having dimensions of about 2 mm by 3 mm). The film 302 and electrodes 304a,b are attached to a rigid structure, such as a housing 306, for mounting above the surface of the disc at a safe distance (e.g. about 400 μm or more) from the disc surface to reduce contact with the disc during shock. For example, the sensor 300 may be spaced far enough apart from the disc that a shock to the disc of less than 300G will not cause the disc to contact the sensor 300.

The film 302 and electrodes 304a,b may be mounted directly on the housing 306 so that there is no air between the film 302 and the housing 306. Thus, film may not deflects like a typical diaphragm in a gas pressure sensor. Transduction occurs when the pressure waves impinge on film 302, generating stress in the film 302. The film 302 responsively produces a charge that is proportional to the stress. This charge is sensed as an electric field across the electrodes 304a,b. Due to the fast dissipation of charge, the film 302 has a low frequency response limit, which prevents/reduces it from acting as a DC sensor. However, the film 302 has a very fast response, which makes it suitable as an AC device.

FIG. 4 illustrates a pressure sensor 300 according to some embodiments mounted adjacent a surface of a rotatable disc 320. As shown therein, a PVDF sensor 300 is mounted on a housing 306 adjacent a data storage surface of a rotatable disc 320 that rotates about an axis of rotation 324. The housing 306 can be mounted on a disc housing 310 that supports the rotatable disc 320.

Referring to FIGS. 3 and 4, the housing 306 may be formed of a lightweight material capable of supporting the film 302 and electrodes 304a,b. In some embodiments, the housing 306 may include aluminum, ceramic, and/or plastic. In some embodiments, the material of the housing 306 may be chosen to limit or reduce reflection of electromagnetic energy to/from the film 302.

The pressure sensor 300 detects vibration 330 of the rotatable disc 320 in a direction normal to a plane defined by the surface of the rotatable disc 320 in response to pressure variation of a gaseous atmosphere surrounding the rotatable disc 320 caused by the disc vibration.

The use of a pressure sensor 300 to detect disc modes may provide significant benefits relative to the use of other types of sensors, such as capacitive sensors. For example, a capacitive sensor may have to be positioned relatively closely to the disc surface (e.g. 50 μm or so) in order to be useful for disc mode detection. At such a distance, undesirable contact may occur between the sensor and the disc surface even at relatively low shocks. Furthermore, capacitive sensors require external power and may require complicated circuitry to detect changes in capacitance due to disc mode vibration. In contrast, the sensor 300 can be positioned a safe distance from the disc surface to reduce the possibility of contact with the disc surface. Furthermore, because the sensor 300 generates a voltage directly in response to pressure variation adjacent the disc 320, an external power source will not be needed, and only a charge amplifier 301 may be needed to generate a voltage signal that can be used to generate the feed-forward control signal 220.

Sensing transduction is based on the stress, due to air pressure, caused by disc vibration, on the film 302 attached to the structure 306. The spatially integrated charge induced within the film 302 is sensed as voltage between the top and bottom electrodes 304a, 304b. The induced field (E) across the electrodes equals the product of stress (ρ) and the largest PVDF strain constant (g₃₃) as follows:

E=ρg₃₃(V/m)

Accordingly, a PVDF film 302 including electrodes 304a, 304b is mounted on a sensor housing 306. The housing 306 is positioned such that the surface of the film 302 is at a safe distance from the surface of the disc.

A PVDF film according to some embodiments may have dimensions of length (l)=about 1 mm to about 3 mm, width (w)=about 0.5 mm to about 2 mm and thickness=about 10 μm to about 50 μm. A PVDF film according to some embodiments may have dimensions of length (l)=3 mm, width (w)=2 mm and thickness=28 μm. The PVDF material has three dimensional strain constants as follows:

g₃₁=0.216 V/m/N/m²

g₃₂=19 V/m/N/m²

g₃₃=−339 V/m/N/m²

Accordingly, the PVDF film 302 in the sensor 300 may be oriented to take advantage of the high g₃₃ strain constant.

Other methods of implementation may include installation of the film on a housing that extends over each surface of the each disc in a multi-disc drive. Alternatively, a single sensor 300 may be used for each disc 320. Accordingly, a disc drive according to some embodiments may include one pressure sensor 300 per disc surface and/or one pressure sensor 300 per disc. At most, two conductors are needed to receive the output of the sensor 300. A single conductor may be used for each sensor 300 when using a common ground attached to one electrode of each sensor 300.

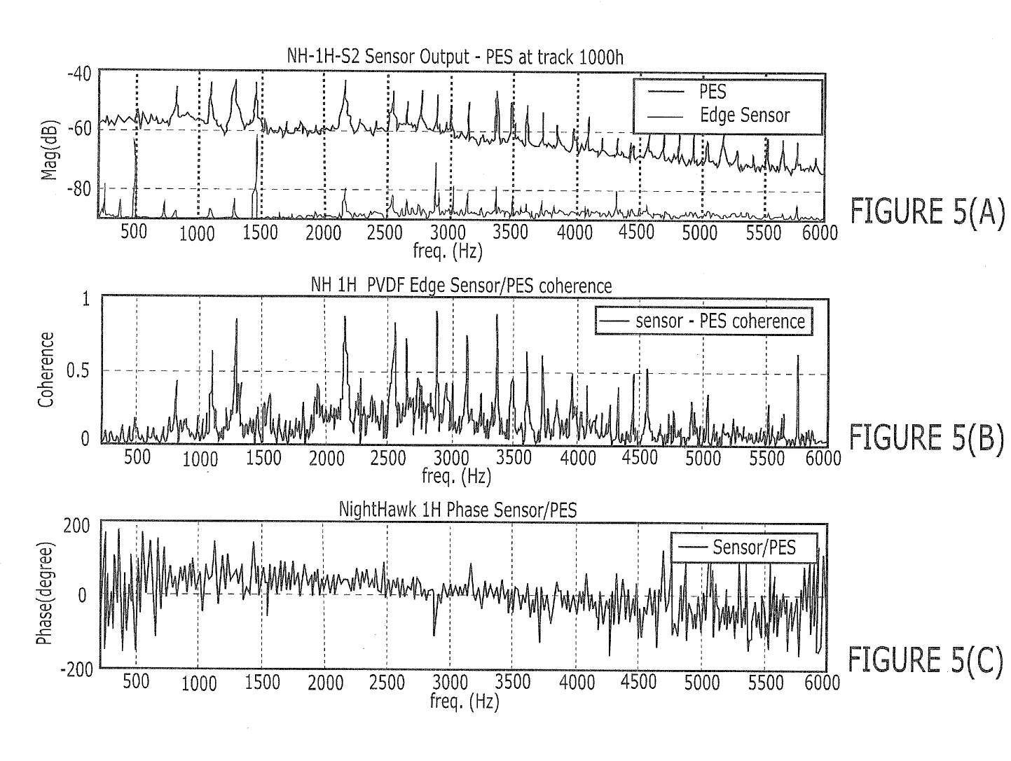

FIG. 5 is a graph that illustrates the correlation of observed disc modes measured with a PVDF sensor 300 and measured using the PES signal for a high capacity disc drive. In particular, a PVDF sensor was positioned adjacent a disc in a disc drive having the following modes (in Hz): 806.3, 1275.0, 2150.0, 2537.5, 3362.5, and 4318.8. FIG. 5(A) is a graph of sensor output and PES versus frequency. FIG. 5(B) is a graph illustrating coherence between the sensor output and the PES, and FIG. 5(C) illustrates the phase relationship between the sensor output and the PES. As shown in FIG. 5 and Table 1, the output of the PVDF sensor shows high correlation to PES for the disc modes. The strong correlation of the observed disc modes measured with the PVDF sensor and PES demonstrates the ability of the sensor 300 to accurately identify disc modes.

TABLE 1
PES/Sensor Coherence

| f(Hz) | PES/Sensor Coherence |
|---|---|
| 806.3 | 0.43 |
| 1275.0 | 0.85 |
| 2150.0 | 0.89 |
| 2537.5 | 0.83 |
| 3362.5 | 0.90 |
| 4318.8 | 0.83 |

Furthermore, a pressure sensor according to some embodiments may have the sensing capability to identify different types of time invariant or impulsive disturbance events inside a disc drive. Examples of such disturbances include motor pure tones (RRO disturbance), ramp contact detect, latch opening, coil popping, shock, external vibration and excitation due to sounds/music, etc. That is, both the output of the sensor 300 and the PES include many matching frequency components not due to disc modes. This indicates that the sensor 300 can be used to identify many types of steady state disturbances or impulsive events inside a disc drive.

Some embodiments provide a disc mode sensor for a disc drive that includes a PVDF film as a sensing element. A PVDF-based disc mode sensor according to some embodiments can have a relatively simple design that is inexpensive to manufacture and incorporate within a disc drive housing. Furthermore, the circuitry required to implement an adaptive feed-forward control system may be simplified, because a PVDF-based disc mode sensor may not require an external power source and may generate an output voltage signal directly in response to pressure variation adjacent a disc surface.

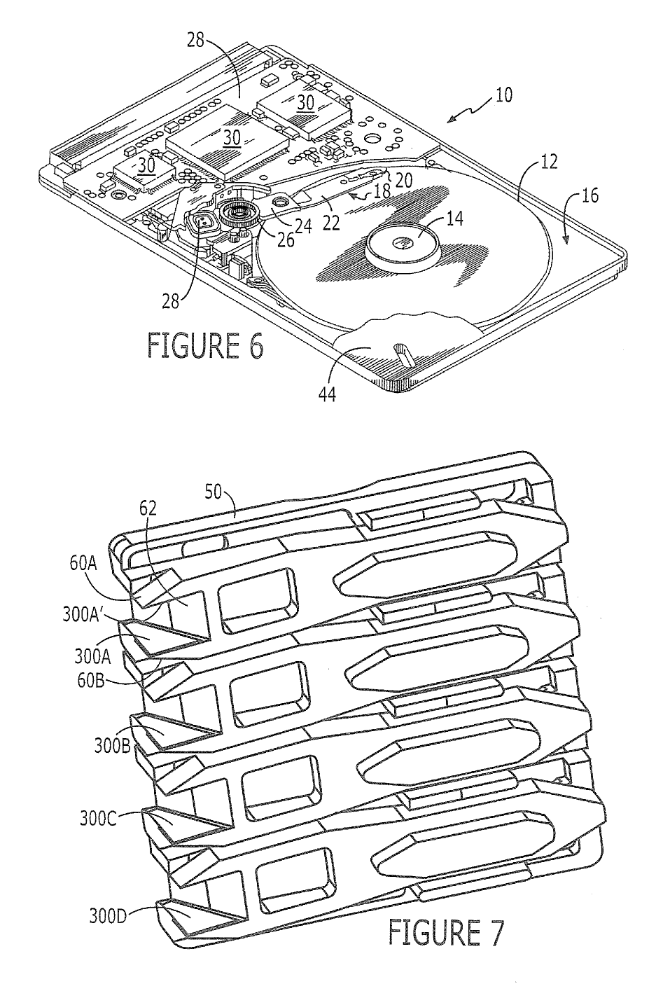

A simplified diagrammatic representation of a disc drive, generally designated as 10, is illustrated in FIG. 6. The disc drive 10 includes a disc stack 12 (illustrated as a single disc in FIG. 6) that is rotated about a hub 14 by a spindle motor mounted to a base plate 16. The disc drive includes a housing 44 that surrounds and protects the disc stack 12 and associated hardware and electronics of the disc drive 10.

The disc stack 12 includes a plurality of discs. An actuator arm assembly 18 is also mounted to the base plate 16. The disc drive 100 is configured to store and retrieve data responsive to write and read commands from a host device. A host device can include, but is not limited to, a desktop computer, a laptop computer, a personal digital assistant (PDA), a digital video recorder/player, a digital music recorder/player, and/or another electronic device that can be communicatively coupled to store and/or retrieve data in the disc drive 100.

The actuator arm assembly 18 includes one or more read/write heads (or transducers) 20 mounted to a flexure arm 22 which is attached to an actuator arm 24 that can rotate about a pivot bearing assembly 26. The heads 20 may, for example, include a magnetoresistive (MR) element and/or a thin film inductive (TFI) element. The actuator arm assembly 18 also includes a voice coil motor (VCM) 28 which radially moves the heads 20 across the disc stack 12. The spindle motor 15 and actuator arm assembly 18 are coupled to a controller, read/write channel circuits, and other associated electronic circuits 30 which can be enclosed within one or more integrated circuit packages mounted to a printed circuit board (PCB) 32. The controller, read/write channel circuits, and other associated electronic circuits 30 are referred to below as a “controller” for brevity. The controller 30 may include analog circuitry and/or digital circuitry, such as a gate array and/or microprocessor-based instruction processing device.

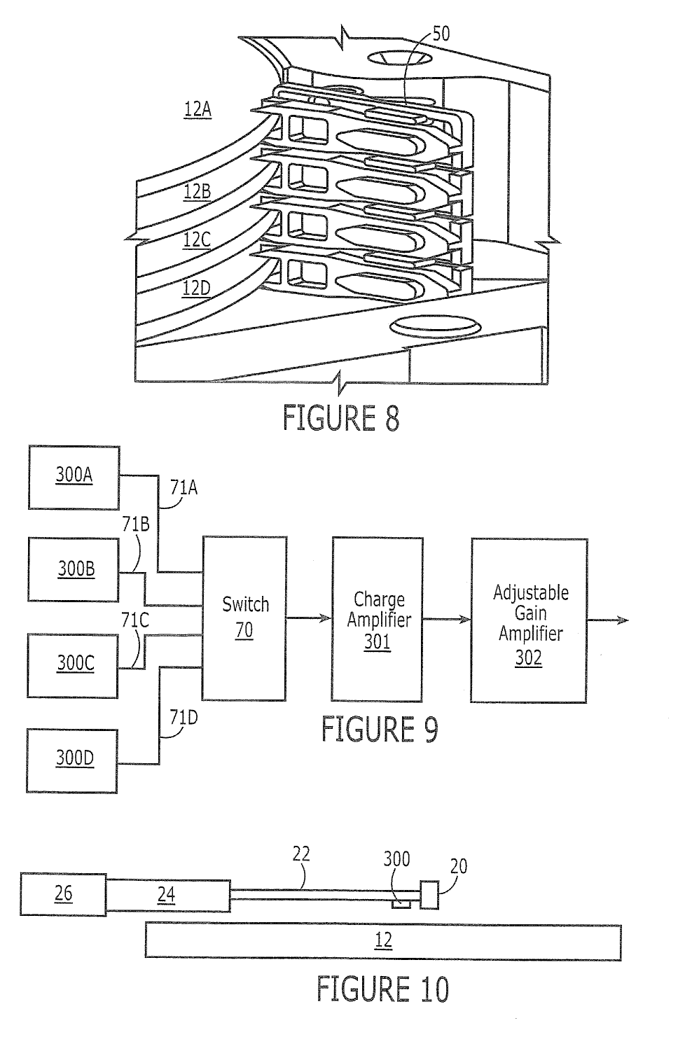

FIG. 7 illustrates a disc ramp assembly 50 for use in a 4-disc/8-head disc drive including a plurality of pressure sensors according to some embodiments, while FIG. 8 illustrates positioning of a disc ramp assembly including a plurality of pressure sensors according to some embodiments adjacent a disc stack in a disc drive.

Disc ramp assemblies are commonly used in disc drives to provide a location to receive and secure, or park, the transducers when the disc is not in use. Referring to FIGS. 7 and 8, the disc ramp assembly 50 includes eight ramps provided in respective ramp pairs 60A, 60B so as to provide a ramp on either side of each disc (i.e., one ramp per head 20). In some embodiments, the ramps may be positioned on opposing sides of an opening 62 that is positioned over an edge of a disc 12A-12D. As shown in FIG. 7, a plurality of sensors 300A-300D are positioned on inner surfaces of the openings 62, so that each sensor 300A-300D is positioned adjacent a surface of a respective disc 12A-12D. In some embodiments, one sensor 300A-300D may be provided per disc while in other embodiments, one sensor 300A-300D may be provided per disc surface (i.e., two sensors per disc 12A-12D). For example, a second sensor 300A′ may be mounted within the opening 62 adjacent the ramp 60A and across the opening 62 from the sensor 300A.

Vibration of the discs 12A-12D causes pressure variation in the gas (e.g., air) adjacent the discs 12A-12D, which pressure variation is sensed by the sensors 300A-300D. It will be appreciated that although disc drives generally include air within the drive housing 44, other gases could be provided within the disc drive housing 44.

The high sensitivity of the PVDF film in the sensors 300A-300D facilitates a response due to extremely small pressure fluctuations. This in turn allows measurement of disc modes, as perturbation in the air pressure, at relatively large distances away from the discs 12A-12D. This attribute is attractive since it allows installation of the sensor 300A-300D at a relatively large distance (e.g. 400 μm) away from the discs 12A-12D to prevent contact between the discs 12A-12D and the sensors 300A-300D during a shock event. The large distance that the sensors 300A-300D can be mounted from the discs 12A-12D is important for mass production and installation of the sensor 300A-300D in single or multi-platter disc drives. With a larger allowed gap, manufacturing tolerances for positioning the sensor 300A-300D at the edge of the discs 12A-12D will be relaxed, thereby reducing the cost for fabrication and installation of the sensor housing.

The PVDF film of the sensors 300A-300D may be pre-assembled in/on a sensor housing designed to be installed in single- or a multi-platter platter drive. The housing of the sensor 300A-300D may resemble the structure of disc head ramps, such as are typically used in disc drives. In some embodiments, the structure of the ramp can also serve as the housing for the sensor. For example, FIG. 7 shows a possible location for installation of the PVDF film sensors 300A-300D oil a ramp 50 used in a 4-disc/8-head drive. Such installation would be possible due to the small area of the PVDF film needed. This approach will allow precise positioning of the sensors 300A-300D above the edge of the discs 12A-12D using a part that is already in use in disc drives.

Installation of the sensor in/on the ramp assembly 30 may allow precise positioning of the sensors 300A-300D at a desired distance from the surface of each disc 12A-12D using an existing part.

The ramp 50 part may be modified to 1) optimize the area of the film for the sensor 300A-300D, 2) provide a conduit for electrical traces from each film, and 3) include the charge amplifier and an optional switching circuit to rout data from a single sensor at one time.

FIG. 9 is a simplified diagram illustrating electrical connection of sensors 300A-300D according to some embodiments. As shown therein, each sensor 300A-300D is connected through a switch 70 to a charge amplifier 301. Each sensor 300A-30D may be coupled to the switch 70 by respective signal lines 71A-D that include at most two traces (one trace if a common electrical ground can be established). The switch 70 may, for example, sequentially connect the sensors 300A-300D to the charge amplifier 301 via analog time division multiplexing. A single charge amplifier 301 may be used, since the output of only one sensor 300A-300D will be used for the matching head under track follow or settle mode control. The switch 70 and the charge amplifier 301 may be positioned next to or on the sensor housing (such as on the ramp assembly 50) to reduce noise and/or improve signal to noise ratio (SNR). This may reduce component cost while reducing the number of electrical traces that extend from the sensor assembly to two.

The output of the sensors 300A-300D will have some variation with temperature. In particular, there will be some reduction in the output of the PVDF film at higher temperatures. Within the disc drive, the reduction in the output of the sensor can be accounted for using an adjustable gain that can be modified by the drive electronics 30 based on the sensed temperature of the drive. Accordingly, an adjustable gain amplifier 302 can be provided between the charge amplifier and the adaptive disc mode sensing amplifier 201. It will be appreciated that although the adjustable gain amplifier 302 is illustrated as a separate block, the adjustable gain amplifier 302 could be implemented within software in the servo controller 104.

Referring to FIG. 10, in other embodiments, a sensor 300 may be positioned at the distal end (tip) of the flexure arm 22, with the film of the sensor 300 facing the surface of the disc 12. This approach provides the ability to co-locate the sensor 300 with the head 20, as well as the ability to position the sensor 300 at different disc radii. In these embodiments, the sensor electrical conduit may be added to the existing head trace assembly.

The output of the sensor(s) 300A-300D may be used within a closed feedback control loop using the filtered-x LMS algorithm. The LMS algorithm minimizes the error (PES) based on the sensed data representing the amplitude of the disc modes or other disturbances. Such error minimization (LMS; i.e. minimization of the least mean square of the error) will not require very precise calibrated sensor data but acceptable SNR to allow correlation between the frequency content of PES and the sensor data.

In the drawings and specification, there have been disclosed typical preferred embodiments of the invention and, although specific terms are employed, they are used in a generic and descriptive sense only and not for purposes of limitation, the scope of the invention being set forth in the following claims.

1. An apparatus for sensing vibration of a rotatable disc, comprising:
a pressure sensor adjacent to and spaced apart from a surface of the rotatable disc and that generates an electric signal indicative of a pressure variation caused by vibration of the rotatable disc.

2. The apparatus of claim 1, wherein the pressure sensor comprises:
a polyvinylidene fluoride (PVDF) film; and
a pair of electrodes on opposite sides of the PVDF film.

3. The apparatus of claim 1, wherein the pressure sensor is spaced far enough apart from the rotatable disc that a shock to the rotatable disc of less than 300 G will not cause the rotatable disc to contact the pressure sensor.

4. The apparatus of claim 3, wherein the pressure sensor is spaced at least about 400 micrometers from the surface of the rotatable disc.

5. The apparatus of claim 1, further comprising a rotatable disc stack including a plurality of rotatable discs, each of which includes first and second data storage surfaces and a plurality of the pressure sensors positioned adjacent respective ones of the rotatable discs in the rotatable disc stack.

6. The apparatus of claim 5, wherein respective ones of the plurality of pressure sensors are positioned adjacent both the first and second data storage surfaces of the plurality of rotatable discs.

7. The apparatus of claim 1, wherein the pressure sensor detects pressure variation caused by vibration of the rotatable disc in a direction normal to a plane defined by the surface of the rotatable disc.

8. The apparatus of claim 2, wherein the PVDF film has a thickness (t) of about 10 micrometers to about 50 micrometers.

9. The apparatus of claim 1, further comprising:
a temperature sensor; and
a variable gain amplifier that is coupled to the pressure sensor and that amplifies the electric signal, wherein gain of the variable gain amplifier is adjusted in response to an output of the temperature sensor.

10. (canceled)

11. The apparatus of claim 1, further comprising:
an actuator arm assembly configured to position a read/write head adjacent a data storage surface of the rotatable disc;
wherein the pressure sensor is positioned at an end of the actuator arm assembly.

12. The apparatus of claim 1, further comprising:
an actuator arm assembly configured to position a read/write head adjacent a data storage surface of the rotatable disc; and
a disc ramp assembly adjacent the rotatable disc and including a ramp that receives and secures the read/write head;
wherein the pressure sensor is mounted on the disc ramp assembly adjacent the rotatable disc.

13. The apparatus of claim 12, further comprising a charge amplifier that amplifies the electric signal generated by the pressure sensor, wherein the charge amplifier is mounted on the disc ramp assembly.

14. The apparatus of claim 12, wherein:
the data storage surface of the rotatable disc comprises a first data storage surface of the rotatable disc, the rotatable disc further comprising a second data storage surface opposite the first data storage surface;
the actuator arm assembly comprises first and second actuator arms configured to position respective first and second read/write heads adjacent the first and second data storage surfaces of the rotatable disc;
the ramp comprises a first ramp that receives and secures the first read/write head, and the disc ramp assembly includes a second ramp that receives and secures the second read/write head;
the first and second ramps are positioned on opposite sides of an opening in the ramp assembly that receives the rotatable disc;
the pressure sensor comprises a first pressure sensor mounted within the opening adjacent the first ramp; and
the apparatus further comprises a second pressure sensor mounted within the opening adjacent the second ramp and across the opening from the first pressure sensor.

15. The apparatus of claim 12, further comprising:
a switch; and
first and second signal lines extending between the first and second pressure sensors, respectively, and the switch.

16. A servo control system that controls a position of a read/write head relative to a track on a rotatable disc, comprising:
a pressure sensor adjacent to and spaced apart from a surface of the rotatable disc and that detects a pressure variation caused by vibration of the rotatable disc and generates an electric signal in response to the pressure variation; and
an adaptive feed-forward vibration compensation circuit coupled to the servo control system and to the pressure sensor and that generates a feed-forward control signal in response to the electric signal;
wherein the servo control system controls the position of the read/write head in response to the feed-forward control signal.

17. The servo control system of claim 16, wherein the pressure sensor comprises:
a polyvinylidene fluoride (PVDF) film; and
a pair of electrodes on opposite sides of the PVDF film.

18. A method of controlling a position of a read/write head of a rotatable disc, comprising:
generating an electric signal indicative of a pressure variation caused by vibration of the rotatable disc using a pressure sensor; and
generating a control signal in response to the electric signal.

19. The method of claim 18, wherein the pressure sensor comprises:
a polyvinylidene fluoride (PVDF) film; and
a pair of electrodes on opposite sides of the PVDF film.

20. The method of claim 18, further comprising positioning the pressure sensor far enough apart from a surface of the rotatable disc that a shock to the rotatable disc of less than 300 G will not cause the rotatable disc to contact the pressure sensor.
